(19) United States
(12) Patent Application Publication
(10) Pub. No.: US 2023/0121019 A1
(43) Pub. Date: Apr. 20, 2023

(54) ENGINE GENERATOR

(71) Applicant: YAMAHA HATSUDOKI KABUSHIKI KAISHA, Iwata-shi (JP)

(72) Inventors: Shohei ISHIDA, Shizuoka (JP); Masafumi MASUDA, Shizuoka (JP)

(21) Appl. No.: 18/083,260

(22) Filed: Dec. 16, 2022

Related U.S. Application Data
(63) Continuation-in-part of application No. PCT/JP2020/024237, filed on Jun. 19, 2020.

(51) Int. Cl. F02N 11/14; F02N 11/04; F02B 63/04; H02K 7/18

(52) U.S. Cl. CPC F02N 11/14; F02N 11/04; F02B 63/042; H02K 7/1815

(57) ABSTRACT

An engine generator coupled to an external battery. The engine generator includes: an engine; a motor generator configured to apply a starting force to the engine at a start of the engine, and to perform power generation by a driving force of the engine during driving of the engine;

a first step-down section and an engine accessory, the first step-down section being configured to step down a voltage of the external battery to obtain a first stepped-down voltage, and supply the first stepped-down voltage to the engine accessory; and a power converter that converts power of the external battery and supplies the converted power to the motor generator.

### CROSS REFERENCE TO RELATED APPLICATIONS

This is a continuation-in-part application of International Application PCT/JP2020/024237 filed on Jun. 19, 2020, the contents of which are incorporated herein by reference.

### TECHNICAL FIELD

The present teaching relates to an engine generator.

### BACKGROUND ART

An engine generator that starts an engine by driving a generator (alternator) as a starter motor using power of an attachable/detachable battery is disclosed in Patent Document 1.

The engine generator disclosed in Patent Document 1 described above is configured such that a battery that supplies power for staring the engine to the starter motor is freely attached and detached, and thus, an increase in size of the engine generator is avoided.

### CITATION LIST

### Patent Document

Patent Document 1: Japanese Patent Application Publication No. 2018-168750

### SUMMARY OF INVENTION

### Technical Problem

The engine generator disclosed in Patent Document 1 described above needs a storage battery that stores generated power. The storage battery used for supplying power to a high load device or the like is, for example, a high voltage battery having a voltage of 48 V.

In a known engine generator, an engine starting battery of 12V is used for starting an engine. Therefore, the known engine generator does not drive the engine by a high voltage storage battery but drives the engine using the battery of 12 V for starting the engine. That is, the known engine generator needs a battery of 12 V different from a voltage of a high voltage storage battery.

It is therefore an object of the present teaching to provide an engine generator configured to use one system of an external battery as a power source and capable of starting and driving an engine by the external battery.

### Solution to Problem

The inventors of the present teaching conducted studies on an engine generator that does not require a plurality of types of batteries having different voltages. The inventors of the present teaching have devised a configuration of an engine generator configured to use one system of a high voltage external battery as a power source. Through an intensive study, the inventors of the present teaching have reached the following configuration.

An engine generator according to one embodiment of the present teaching is an engine generator that includes an engine and a motor generator configured to apply a starting force to the engine at a start of the engine and perform power generation by a driving force of the engine during driving of the engine, and charges power generated by the motor generator in an external battery, the engine generator including a first step-down section that steps down a voltage of the external battery and supplies power to an engine accessory, and a power converter that converts power of the external battery and supplies the converted power to the motor generator.

The engine generator of this embodiment is configured such that power for driving the engine generator is supplied by one system of the external battery. For example, the engine generator is operated by one external battery without using a plurality of types of batteries, such as an engine driving battery of 12 V and an external battery of 48 V charged by the motor generator. Thus, the engine generator having high versatility can be achieved.

In another aspect, the engine generator according to one embodiment of the present teaching preferably includes the following configuration. The engine generator according to this embodiment further includes a controller that controls driving of the first step-down section and the power converter, and a second step-down section that steps down the voltage of the external battery and supplies power to the controller, wherein the power converter converts direct current (DC) power of the external battery to alternating current (AC) power and supplies power to the motor generator, and converts AC power generated by the motor generator to DC power and outputs the DC power.

The first step-down section steps down the voltage of the external battery and supplies power to the engine accessory. The second step-down section steps down the voltage of the external battery and supplies power to the controller that controls the first step-down section and the power converter. Thus, the engine generator can be operated by the one external battery.

In another aspect, the engine generator according to one embodiment of the present teaching preferably includes the following configuration. The second step-down section steps down the voltage of the external battery and supplies power to the controller at all times.

Thus, the controller can control the operation of the engine generator at all times.

In another aspect, the engine generator according to one embodiment of the present teaching preferably includes the following configuration. The controller performs control such that, when a state of the engine is shifted from a driving state to a stop state, the power converter is continuously driven and is caused to convert the AC power generated by the motor generator to DC power and output the converted DC power, and driving of the first step-down section that supplies power to the engine accessory is stopped.

The engine is stopped by stopping of power supply to the engine accessory. On the other hand, the power converter is continuously driven. Thus, the power converter can convert AC power to DC power until power generated by the motor generator becomes zero.

In another aspect, the engine generator according to one embodiment of the present teaching preferably includes the following configuration. The controller stops driving of the first step-down section and the power converter during a standby time of the engine generator.

The controller stops driving of the first step-down section and the power converter during a standby time of the engine generator. Thus, according to this embodiment, a power consumption of the external battery can be reduced.

In another aspect, the engine generator according to one embodiment of the present teaching preferably includes the following configuration. The controller monitors a behavior of the engine generator and, in a case where operations of the first step-down section and the power converter are stopped for a certain time or more, shifts an operation of the controller to an operation of reducing a power consumption.

Thus, a power consumption of the controller is reduced and a consumption of the external battery is suppressed.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification specify the presence of stated features, steps, operations, elements, components, and/or their equivalents, but do not preclude the presence or addition of one or more steps, operations, elements, components, and/or groups thereof

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention.

Embodiments of an engine generator according to the present teaching will be herein described.

In the following description, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

### [Motor Generator]

In this specification, a motor generator has a function of a generator that is driven by an engine and generates power and a function as a starter motor that applies a driving force to the engine by power of a battery when the engine is started.

### [External Battery]

In this specification, an external battery refers to a battery provided outside an engine generator. That is, the external battery is provided separately from an engine generator. For example, the external batteries include a high voltage battery that supplies power to a motor of an electric vehicle.

### [Power Converter]

In this specification, a power converter refers to a device that converts AC power to DC power or a device that converts DC power to AC power.

### [Engine Accessory]

In this specification, an engine accessory refers to a necessary device for driving an engine. For example, the engine accessories include an oil pump, a water pump, an injector, a throttle motor, an ignition device, or the like.

### [Engine Controller]

In this specification, an engine controller refers to a device that controls driving of an engine. For example, the engine controller performs control of an ignition mechanism, a fuel system, a supply and exhaust system, or the like.

### [Standby Time of Engine Generator]

In this specification, a standby time of an engine generator refers to a state where a stop state where an operation of the engine generator is stopped can be shifted to a driving state where the engine generator is operated.

### Advantageous Effects of Invention

One embodiment of the present teaching provides an engine generator configured to use one system of an external battery as a power source and capable of starting and driving an engine by the external battery.

### BRIEF DESCRIPTION OF DRAWINGS

FIG. 1 is a block diagram illustrating a configuration of an engine generator according to a first embodiment of the present teaching.

FIG. 2 is a block diagram illustrating a configuration of an engine generator according to a second embodiment of the present teaching.

FIG. 3 is a block diagram illustrating a configuration of an engine generator according to a third embodiment of the present teaching.

FIG. 4 is a block diagram illustrating a configuration of an engine generator according to a fourth embodiment of the present teaching.

### DESCRIPTION OF EMBODIMENTS

Embodiments will be described hereinafter with reference to the drawings. The dimensions of components in the drawings do not strictly represent actual dimensions of the components and dimensional proportions of the components.

### First Embodiment

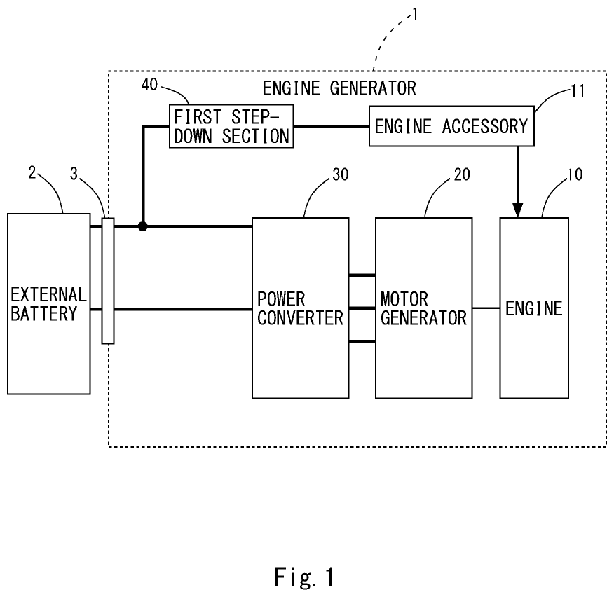

FIG. 1 illustrates a configuration of an engine generator 1 according to a first embodiment of the present teaching. The engine generator 1 includes an engine 10, a motor generator 20, a power converter 30, a first step-down section 40, and an engine accessory 11. The engine generator 1 is mounted, for example, on an unmanned ground vehicle (UGV). The engine generator 1 charges a driving battery (external battery 2) mounted on UGV.

The engine generator 1 includes a connector 3. The external battery 2 is coupled to the connector 3. AC power generated by the motor generator 20 is converted to DC power by the power converter 30. The DC power output from the power converter 30 is charged in the external battery 2.

The external battery 2 of this embodiment is, for example, a high voltage lithium-ion battery having a voltage of 48 V. A voltage of the external battery 2 is a higher voltage than a voltage for driving the engine accessory 11, which will be described later.

The engine 10 is, for example, an air-cooled engine using gasoline as fuel. Although not specifically illustrated, the engine 10 includes a piston that reciprocates in a cylinder and a crank shaft (output shaft) that rotates in synchronization with the piston. Power of the engine 10 is output to the motor generator 20 via the crank shaft. Note that the engine 10 is not limited to the air-cooled engine and may be a water-cooled engine.

The motor generator 20 applies a starting force to the engine 10 at a start of the engine 10. The motor generator 20 performs power generation by a driving force of the engine 10 during driving of the engine 10. That is, the motor generator 20 has a function of a generator that is driven by an engine and generates power and a function as a starter motor that applies a driving force to the engine by power of a battery at a start of the engine.

Although not specifically illustrated, the motor generator 20 includes a rotor that is connected to the crank shaft of the engine 10 and rotates integrally with the crank shaft, and a stator arranged concentrically with the rotor. The rotor includes a permanent magnet. The stator includes, for example, a three-phase winding wire.

Power generated by the motor generator 20 is output to the power converter 30. The power converter 30 converts three-phase AC power generated by the motor generator 20 to DC power. The converted DC power is output to the external battery 2 via the connector 3. The external battery 2 is charged by the DC power.

On the other hand, the power converter 30 can convert DC power supplied from the external battery 2 via the connector 3 to three-phase AC power and output the three-phase AC power to the motor generator 20. In the motor generator 20, a rotating magnetic field is generated around the winding wire of the stator by the three-phase AC power supplied from the power converter 30. Accordingly, the rotor of the motor generator 20 rotates.

As described above, when the rotor of the motor generator 20 rotates, the crank shaft of the engine 10 rotates, and therefore, the engine 10 can be started by cranking. Note that the engine accessory 11, such as an ignition plug igniting an air fuel mixture in a combustion chamber, a throttle motor adjusting an opening degree of a throttle valve provided in an intake pipe, an injector injecting fuel to generate an air fuel mixture, or the like, is operated at a start of the engine.

The engine accessory 11 is operated by a lower voltage than the voltage of the external battery 2, that is, for example, a voltage of 12 V. Therefore, in this embodiment, the DC power of the external battery 2 is input to the first step-down section 40.

The first step-down section 40 steps down the voltage of the external battery 2 to a predetermined voltage for operating the engine 10. The first step-down section 40 steps down the voltage of the external battery 2 to a driving voltage of the engine accessory 11. The first step-down section 40 is constituted, for example, by a DC-to-DC converter. For example, the first step-down section 40 steps down a voltage of 48 V to a voltage of 12 V. The first step-down section 40 applies a voltage stepped down for operating the engine 10 to the engine accessory 11.

In a case where the engine 10 is started by power of the external battery 2, the external battery 2 supplies DC power to each of the power converter 30 and the first step-down section 40 via the connector 3.

The power converter 30 converts the DC power supplied from the external battery 2 to three-phase AC power and inputs the three-phase AC power to the motor generator 20.

When starting of the engine 10 is completed, the power converter 30 blocks power supply from the external battery 2. Thereafter, the rotor of the motor generator 20 is rotatably driven by the engine 10, and thus, the motor generator 20 generates power. The generated power is input to the power converter 30. The power converter 30 converts the three-phase power generated by the motor generator 20 to DC power. The converted DC power is output to the external battery 2 via the connector 3.

The engine generator 1 of the first embodiment supplies power for driving the engine generator 1 using one system of the external battery 2. As described above, according to the first embodiment, the engine generator 1 is operated by one external battery 2 without using a plurality of types of batteries, such as an engine driving battery of 12 V, an external battery 2 of 48 V charged by the motor generator 20, or the like. Thus, the engine generator 1 having high versatility can be achieved.

### Second Embodiment

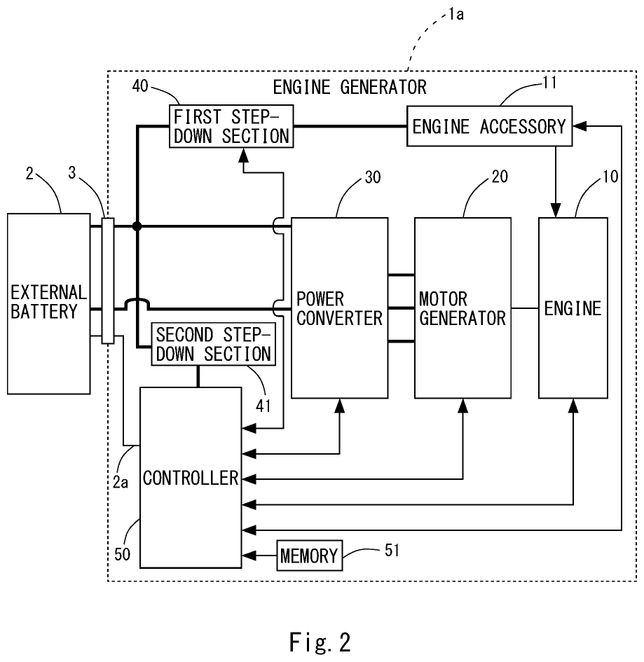

FIG. 2 illustrates a configuration of an engine generator 1a according to a second embodiment of the present teaching. The engine generator 1a of the second embodiment includes, in addition to components of the engine generator 1 of the first embodiment, a controller 50 that controls driving of the first step-down section 40 and the power converter 30, and a second step-down section 41.

DC power of the external battery 2 is input to the second step-down section 41 via the connector 3. The second step-down section 41 steps down a voltage of the external battery 2 and supplies power to the controller 50. The second step-down section 41 steps down the voltage of the external battery 2 to a driving voltage of the controller 50. That is, the second step-down section 41 is, for example, a DC-to-DC converter that steps down a DC voltage of 48 V to a DC voltage of 5 V.

The controller 50 controls driving of the first step-down section 40 and the power converter 30. The controller 50 is constituted, for example, by a microcomputer and executes each of various control operations in accordance with a control program stored in a memory 51. Note that the memory 51 may be constituted by a memory device provided inside the controller 50 and also may be constituted by an external memory medium coupled to the controller 50.

The controller 50 is operated by supply of a voltage stepped down by the second step-down section 41. The engine generator 1a of the second embodiment of the present teaching can be operated by one external battery 2.

The controller 50 is coupled to the external battery 2 via the connector 3 by a communication line 2a. Battery information, such as internal temperature and a charge state of the external battery 2, or the like, is input to the controller 50 through the communication line 2a.

The controller 50 controls operations of the first step-down section 40 and the power converter 30, based on the battery information input from the communication line 2a. Furthermore, the controller 50 controls an operation of the engine 10, the motor generator 20, the engine accessory 11, or the like.

When the controller 50 determines from the battery information obtained through the communication line 2a that a charge amount of the external battery 2 is lower than a predetermined set charge amount, the controller 50 performs control in which the engine 10 is started to start power generation of the motor generator 20.

The controller 50 controls the power converter 30 to start the engine 10. The power converter 30 converts DC power supplied from the external battery 2 to three-phase AC power and outputs the three-phase AC power to the motor generator 20.

The controller 50 controls an operation of the first step-down section 40. The first step-down section 40 steps down a voltage of the external battery 2 to a predetermined voltage by which the engine 10 is operated. The stepped down voltage is output to the engine accessory 11.

When starting of the engine 10 is completed, the controller 50 controls the power converter 30 such that the power converter 30 blocks power supply from the external battery 2. Thereafter, the rotor of the motor generator 20 is rotatably driven by the engine 10. Thus, the motor generator 20 generates power.

The controller 50 controls driving of the power converter 30 such that the power converter 30 performs an operation of converting three-phase power to DC power. Three-phase AC power generated by the motor generator 20 is input to the power converter 30. The power converter 30 converts the three-phase AC power generated by the motor generator 20 to DC power. The converted DC power is output to the external battery 2 via the connector 3. Thus, the external battery 2 is charged.

Note that, in this embodiment, the second step-down section 41 is configured to step down the voltage of the external battery 2 and supply power to the controller 50 at all times. Thus, the controller 50 can control an operation of the engine generator 1a at all times.

When the controller 50 determines from the battery information input through the communication line 2a that the charge amount of the external battery 2 has reached a predetermined charge amount, the controller 50 stops driving of the engine 10. The controller 50 performs control such that, when a state of the engine 10 is shifted from a driving state to a stop state, the power converter 30 is continuously driven. Thus, the power converter 30 converts AC power generated by the motor generator 20 to DC power and outputs the DC power. Furthermore, the controller 50 performs control such that driving of the first step-down section 40 that supplies power to the engine accessory 11 is stopped. The engine 10 is stopped by stopping of power supply to the engine accessory 11.

By continuously driving the power converter 30 even after driving of the engine 10 is stopped, the power converter 30 can convert AC power to DC power until power generated by the motor generator 20 becomes zero.

Furthermore, the controller 50 performs control such that driving of the first step-down section 40 and the power converter 30 is stopped during a standby time of the engine generator 1a. When the engine generator 1a is in a standby state, the controller stops driving of the first step-down section and the power converter, and thus, a power consumption of the external battery 2 can be reduced.

### Third Embodiment

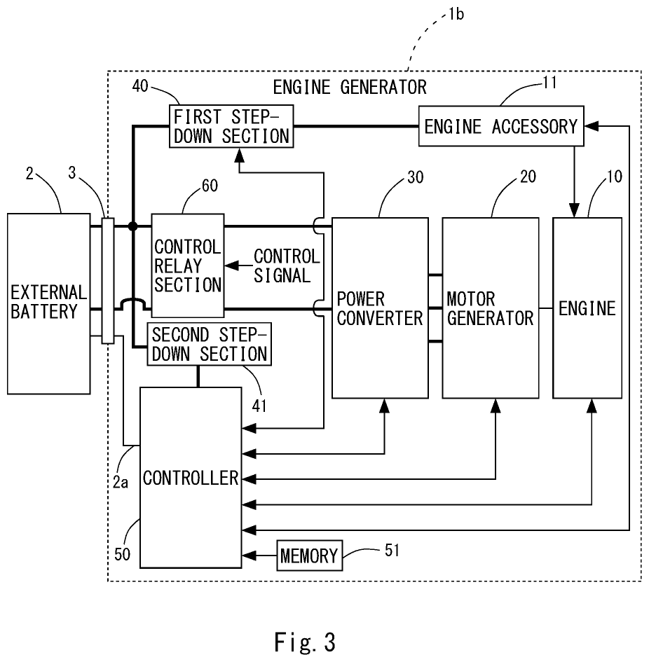

FIG. 3 illustrates a configuration of an engine generator 1b according to a third embodiment of the present teaching. The engine generator 1b of the third embodiment includes a control relay section 60 that is controlled to be turned on and off by the controller 50 between the power converter 30 and the connector 3 in the configuration of the engine generator 1a of the second embodiment.

When the controller 50 determines from the battery information input through the communication line 2a that the charge amount of the external battery 2 has become lower than the predetermined set charge amount, the controller 50 puts the control relay section 60 in an on state and applies DC power to the power converter 30 from the external battery 2. In a case where the motor generator 20 is generating power, the controller 50 keeps the control relay section 60 continuously in the on state. Thus, power converted to DC power by the power converter 30 is output to the external battery 2 via the control relay section 60 and the connector 3. Accordingly, the external battery 2 is charged.

When the power generated by the motor generator 20 has become zero, the controller 50 puts the control relay section 60 in an off state. Thus, charging of the external battery 2 is stopped. Furthermore, the controller 50 keeps the control relay section 60 in the off state during a standby time of the engine generator 1b and suppresses discharging of the external battery 2.

### Fourth Embodiment

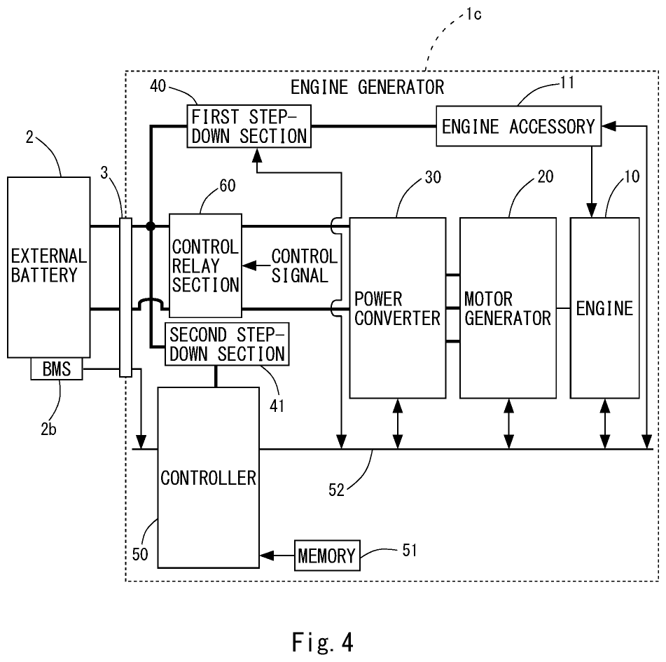

FIG. 4 illustrates a configuration of an engine generator 1c according to a fourth embodiment of the present teaching. In the engine generator 1c of the fourth embodiment, the controller 50 performs each of various types of control via a controller area network (CAN).

The first step-down section 40, the control relay section 60, the power converter 30, the motor generator 20, the engine 10, the engine accessory 11, and a battery management system (BMS) 2b provided in the external battery 2 are coupled to the controller 50 via a bus 52.

Functions of the BMS 2b include abnormality detection of detecting an overvoltage, an excessive temperature rise, an electric leakage, or the like, battery remaining amount estimation at different temperatures and under different charging and discharging environments, or the like. The controller 50 performs charging control, based on a signal input from the BMS 2b. That is, the controller 50 performs control such that charging of the external battery 2 is performed by performing operation control on the first step-down section 40, the control relay section 60, the power converter 30, the motor generator 20, the engine 10, and the engine accessory 11 by the signal of the BMS 2b.

By the above-described functions of the BMS 2b, a lithium-ion battery with high energy density can be utilized.

Furthermore, in the fourth embodiment, the controller 50 monitors a behavior of the engine generator 1c. In a case where the first step-down section 40 and the power converter 30 are stopped for a certain amount of time or more, the controller 50 changes an operation mode of the controller 50 itself. That is, the operation mode of the controller 50 is shifted from a normal operation mode to a low power consumption operation mode in which power consumption is reduced. Thus, the power consumption of the controller 50 is reduced, and a consumption of the external battery 2 is suppressed.

The controller 50 includes an interface to which a wakeup signal is input. For example, in a case where the engine generator 1c is mounted on an UGV, when a switch used for starting driving of the UGV is turned on, the wakeup signal is applied to the controller 50 from the UGV in accordance with this on signal. The operation mode of the controller 50 is shifted from the low power consumption operation mode to the normal operation mode by an input of the wakeup signal.

### Other Embodiments

The embodiments of the present teaching have been described above, but the above-described embodiments are merely examples for carrying out the present teaching. Therefore, the present teaching is not limited to the above-described embodiments and the above-described embodiments can be appropriately modified and implemented without departing from the gist of the present teaching.

In the above-described embodiments, the engine 10 is an air-cooled engine using gasoline as fuel. The engine 10 is not limited to the air-cooled engine and may be a water-cooled engine.

In the above-described embodiments, as the external battery 2, a lithium-ion battery of 48 V is used. As the lithium-ion battery, for example, an iron-phosphate based lithium-ion battery, a lithium manganate-ion battery, an NCA-based lithium-ion battery, or a ternary lithium-ion battery can be used. The external battery 2 is not limited to the above-described batteries, and a nickel hydrogen battery, a lead storage battery, or the like may be used.

In the above-described embodiments, the engine generator 1 is mounted on an UGV and thus is used. The engine generator 1 is not limited thereto, and an engine generator 1 of this embodiment may be applied to various uses other than a use of the engine generator 1 mounted on an UGV. For example, the engine generator 1 of this embodiment can be used for a DC power source in a construction site or the like. For example, the engine generator 1 of this embodiment can be used as a power source used for a transportation means driven by a person.

In the above-described embodiments, the controller 50 controls the engine 10, the engine accessory 11, the motor generator 20, the power converter 30, and the first step-down section 40. An engine generator 1 of this embodiment may include, as a separate component from the controller 50, an engine controller that controls the engine 10 and the engine accessory 11. The controller 50 is coupled to the engine controller via a CAN. The engine controller can be configured to control the engine 10 and the engine accessory 11 in accordance with information of the controller 50 obtained via the CAN.

### INDUSTRIAL APPLICABILITY

The present teaching is applicable to an engine generator charging an external battery.

### REFERENCE SIGNS LIST

1, 1a, 1b, 1c Engine generator

2 External battery

3 Connector

10 Engine

11 Engine accessory

20 Motor generator

30 Power converter

40 First step-down section

41 Second step-down section

50 Controller

1. An engine generator coupled to an external battery, the engine generator comprising:
an engine;
a motor generator configured to apply a starting force to the engine at a start of the engine, and to perform power generation by a driving force of the engine during driving of the engine;
a first step-down section and an engine accessory, the first step-down section being configured to step down a voltage of the external battery to obtain a first stepped-down voltage, and supply the first stepped-down voltage to the engine accessory; and
a power converter that converts power of the external battery and supplies the converted power to the motor generator.

2. The engine generator according to claim 1, further comprising:
a controller that controls driving of the first step-down section and the power converter; and
a second step-down section that steps down the voltage of the external battery to obtain a second stepped-down voltage, and supplies the second stepped-down voltage to the controller, wherein
the power of the external battery is first direct current (DC) power,
the power converter converts the first DC power of the external battery to first alternating current (AC) power, and supplies the first AC power to the motor generator,
the motor generator generates second AC power through the power generation, and
the power converter further converts the second AC power to second DC power, and outputs the second DC power to the external battery.

3. The engine generator according to claim 2, wherein
the second step-down section supplies the second stepped-down voltage to the controller at all times.

4. The engine generator according to claim 2, wherein
the controller controls the driving of the first step-down section and the power converter such that, when the engine is shifted from a driving state to a stop state,
the power converter is continuously driven and is caused to convert the second AC power generated by the motor generator to the second DC power, and to output the second DC power, and
the driving of the first step-down section is stopped.

5. The engine generator according to claim 2, wherein
the controller stops the driving of the first step-down section and the power converter during a standby time of the engine generator.

6. The engine generator according to claim 2, wherein
the controller monitors a behavior of the engine generator and, in a case where operations of the first step-down section and the power converter are stopped for at least a predetermined time, shifts an operation of the controller to thereby reduce power consumption.
